(19) United States
(12) Patent Application Publication
(10) Pub. No.: US 2021/0222056 A1
(43) Pub. Date: Jul. 22, 2021

(54) Delivery of Halogens to a Subterranean Formation

(71) Applicant: Saudi Arabian Oil Company, Dhahran (SA)

(72) Inventors: Desmond Schipper, Houston, TX (US); Katherine Leigh Hull, Houston, TX (US); Younane N. Abousleiman, Norman, OK (US)

(21) Appl. No.: 16/745,428

(22) Filed: Jan. 17, 2020

(51) Int. Cl. C09K 8/74; C09K 8/70; C09K 8/72

(52) U.S. Cl. CPC C09K 8/74; C09K 8/725; C09K 8/706

(57) ABSTRACT

Compositions and methods for treating kerogen in a subterranean formation by generating bromine and other halogens in situ in a subterranean formation. In some implementations, the generation of the bromine or halogen is delayed. This can occur, for example, by the decomposition of precursors, a chemical reaction, the encapsulation of precursors or reactants, or a combination of these approaches.

### TECHNICAL FIELD

This document relates to compositions and methods of delivering halogens to a subterranean formation.

### BACKGROUND

Unconventional source rock formations differ from traditional source rock reservoirs at least in that unconventional source rock formations include the organic material, kerogen. Kerogen can account for 5-10% (10-20% vol) of the source rock formation. Kerogen is a polymer-like intertwined organic material and is known to affect the fracture behavior and hydraulic conductivity of a hydraulic fracture. The kerogen can alter the tensile strength of the rock and as a result, contribute to greater fracturing energy needed to propagate the fracture than in formations without the kerogen material.

### SUMMARY

This disclosure describes compositions and method for generating halogens in situ in a subterranean formation.

The following units of measure have been mentioned in this disclosure:

| Unit of Measure | Full form |
|---|---|
| ° C. | Degree Celsius |
| M | Molarity, moles/liter |
| mmol | milimole |
| mL | milliliter |
| cm | centimeter |
| psi | pounds per square inch |

In some implementations, a composition for treating kerogen in a subterranean formation includes a polyhalogen salt encapsulated in a polymer.

This aspect, taken alone or combinable with any other aspect, can include the following features. The polyhalogen salt includes an anion selected from a group consisting of Br₃⁻, Br₂Cl⁻, BrCl₂⁻, BrI₂⁻, Br₂I⁻, I₃⁻, ClI₄⁻, BrI₆⁻, ICl₂⁻, ICl₄⁻ and I₃Br₄⁻.

This aspect, taken alone or combinable with any other aspect, can include the following features. The polyhalogen salt includes an alkali metal cation or an alkaline earth metal cation.

This aspect, taken alone or combinable with any other aspect, can include the following features. The polyhalogen salt includes a quaternary ammonium cation selected from a group consisting of tetramethylammonium, tetraethylammonium, tetrabutylammonium, benzyltrimethylammonium, and cetyltrimethylammonium.

This aspect, taken alone or combinable with any other aspect, can include the following features. The polyhalogen salt includes a cation selected from a group consisting of imidazolium, pyridinium, and pyrrolidinium.

This aspect, taken alone or combinable with any other aspect, can include the following features. The polyhalogen salt includes a cation with carbon-fluorine bonds.

This aspect, taken alone or combinable with any other aspect, can include the following features. The cation is selected from a group consisting of [P(CF₃)₄]⁺, [N(CF₃)₄]⁺, or bis(tri(4-fluorophenyl)phosphine)iminium.

This aspect, taken alone or combinable with any other aspect, can include the following features. The polymer is a polymer matrix selected from a group consisting of polyvinyl butyral polymer, vinyl acetal polymers, butyral polymers, sytrene/-maleic anyhydride copolymers, and alkylated vinylpyrrolidone copolymers.

This aspect, taken alone or combinable with any other aspect, can include the following features. The polymer is an enteric coating, wherein the enteric coating is selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

In some implementations, a method of treating kerogen in a subterranean formation includes selecting a polyhalogen salt, encapsulating the polyhalogen salt in a polymer, mixing the encapsulated polyhalogen salt in a fluid, and flowing the mixture of encapsulated polyhalogen salt and fluid into a location within the subterranean formation at which kerogen is present.

This aspect, taken alone or combinable with any other aspect, can include the following features. Mixing the encapsulated polyhalogen salt in a fluid includes mixing the polyhalogen salt in a carbon dioxide-based fluid or foam.

This aspect, taken alone or combinable with any other aspect, can include the following features. Mixing the encapsulated polyhalogen salt in a fluid includes mixing the polyhalogen salt in an aqueous-based fluid.

This aspect, taken alone or combinable with any other aspect, can include the following features. Selecting the polyhalogen salt includes selecting a salt comprising an anion from a group consisting of Br₃⁻, Br₂Cl⁻, BrCl₂⁻, BrI₂⁻, Br₂I⁻, I₃⁻, ClI₄⁻, BrI₆⁻, ICl₂⁻, ICl₄⁻, and I₃Br₄⁻.

This aspect, taken alone or combinable with any other aspect, can include the following features. Selecting the polyhalogen salt includes selecting a salt comprising a cation from a group consisting of alkali metal cations or alkaline earth metal cations.

This aspect, taken alone or combinable with any other aspect, can include the following features. Selecting the polyhalogen salt includes selecting a salt that comprises a quaternary ammonium cation selected from a group consisting of tetramethylammonium, tetraethylammonium, tetrabutylammonium, benzyltrimethylammonium, and cetyltrimethylammonium.

This aspect, taken alone or combinable with any other aspect, can include the following features. Selecting the polyhalogen salt includes selecting a salt that comprises a cation selected from a group consisting of imidazolium, pyridinium, and pyrrolidinium cations.

This aspect, taken alone or combinable with any other aspect, can include the following features. Selecting the polyhalogen salt includes selecting a salt that comprises a cation with carbon-fluorine bonds.

This aspect, taken alone or combinable with any other aspect, can include the following features. Selecting the polyhalogen salt includes selecting a salt that comprises a cation selected from a group consisting of [P(CF₃)₄]⁺, [N(CF₃)₄]⁺, and bis(tri(4-fluorophenyl)phosphine)iminium cations.

This aspect, taken alone or combinable with any other aspect, can include the following features. Encapsulating the salt in a polymer includes encapsulating the salt in a polymer matrix selected from a group consisting of polyvinyl butyral polymer, vinyl acetal polymers, butyral polymers, sytrene/-maleic anyhydride copolymers, and alkylated vinylpyrrolidone copolymers.

This aspect, taken alone or combinable with any other aspect, can include the following features. Encapsulating the polyhalogen salt in a polymer includes encapsulating the salt in an enteric coating, wherein the enteric coating is selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

In some implementations, a composition for treating kerogen in a subterranean formation includes at least one of a bromate or chlorate salt, wherein the bromate or chlorate salt is encapsulated in a first polymer, and an acid.

This aspect, taken alone or combinable with any other aspect, can include the following features. The first polymer is a polymer matrix selected from a group consisting of polyvinyl butyral polymer, vinyl acetal polymers, butyral polymers, sytrene/-maleic anhydride copolymers, and alkylated vinylpyrrolidone copolymers.

This aspect, taken alone or combinable with any other aspect, can include the following features. The first polymer is an enteric coating and is selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

This aspect, taken alone or combinable with any other aspect, can include the following features. The acid is encapsulated in a second polymer, wherein the second polymer is a polymer matrix selected from a group consisting of polyvinyl butyral polymer, vinyl acetal polymers, butyral polymers, sytrene/-maleic anhydride copolymers, and alkylated vinylpyrrolidone copolymers.

This aspect, taken alone or combinable with any other aspect, can include the following features. The acid is encapsulated in a second polymer, wherein the second polymer is an enteric coating selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

This aspect, taken alone or combinable with any other aspect, can include the following features. The acid is lactic acid, polylactic acid, chloracetic acid, citric acid, oxalic acid, benzoic acid, furoic acid, or aqueous hydrochloric acid.

In some implementations, a method for treating kerogen in a subterranean formation includes encapsulating at least one of a bromate or chlorate salt in a first polymer, flowing the encapsulated bromate or chlorate salt into a subterranean formation at which kerogen is present, selecting an acid, flowing the acid into a location in the subterranean formation at which kerogen is present, and contacting the bromate or chlorate salt with the acid.

This aspect, taken alone or combinable with any other aspect, can include the following features. Encapsulating at least one of a bromate or chlorate salt in a first polymer includes encapsulating the bromate or chlorate salt in a polymer matrix selected from a group consisting of polyvinyl butyral polymer, vinyl acetal polymers, butyral polymers, sytrene/-maleic anhydride copolymers, and alkylated vinylpyrrolidone copolymers.

This aspect, taken alone or combinable with any other aspect, can include the following features. Encapsulating at least one of a bromate or chlorate salt in a first polymer comprises encapsulating the bromate or chlorate salt in an enteric coating selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

This aspect, taken alone or combinable with any other aspect, can include the following features. Selecting the acid includes selecting the acid from a group consisting of lactic acid, polylactic acid, chloracetic acid, citric acid, oxalic acid, benzoic acid, furoic acid, and aqueous hydrochloric acid.

This aspect, taken alone or combinable with any other aspect, can include the following features. The selected acid is encapsulated in a second polymer, wherein the second polymer is a polymer matrix selected from a group consisting of polyvinyl butyral polymer, vinyl acetal polymers, butyral polymers, sytrene/-maleic anhydride copolymers, and alkylated vinylpyrrolidone copolymers.

This aspect, taken alone or combinable with any other aspect, can include the following features. The selected acid is encapsulated in a second polymer, wherein the second polymer is an enteric coating selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

This aspect, taken alone or combinable with any other aspect, can include the following features. The salt and the acid are flowed into the subterranean formation simultaneously.

In some implementations, a composition for treating kerogen in a subterranean formation includes at least one of a bromate or chlorate salt, wherein the bromate or chlorate salt is encapsulated in a first polymer, and a reducing agent.

This aspect, taken alone or combinable with any other aspect, can include the following features. The reducing agent is encapsulated in a second polymer.

This aspect, taken alone or combinable with any other aspect, can include the following features. The first polymer is a polyvinyl butyral polymer, vinyl acetal polymer, butyral polymer, styrene/-maleic anhydride copolymer, or alkylated vinylpyrrolidone copolymer.

This aspect, taken alone or combinable with any other aspect, can include the following features. The first polymer is an enteric coating, wherein the enteric coating is methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, or zein.

This aspect, taken alone or combinable with any other aspect, can include the following features. The second polymer is a polyvinyl butyral polymer, vinyl acetal polymer, butyral polymer, styrene/-maleic anhydride copolymer, or alkylated vinylpyrrolidone copolymer.

This aspect, taken alone or combinable with any other aspect, can include the following features. The second polymer is an enteric coating, wherein the enteric coating is a methylacrylate-methacrylic acid copolymer, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, or zein.

This aspect, taken alone or combinable with any other aspect, can include the following features. The reducing agent has a standard reduction potential between that of the bromate or chlorate salt and the corresponding halogen.

This aspect, taken alone or combinable with any other aspect, can include the following features. The reducing agent is at least one of sulfur, red phosphorus, bisulfite, iodide, or iodine.

In some implementations, a method for treating kerogen in a subterranean formation includes encapsulating at least one of a bromate or chlorate salt in a first polymer, flowing the encapsulated bromate or chlorate salt into a subterranean formation at which kerogen is present, flowing a reducing agent into the subterranean formation at which kerogen is present, and contacting the bromate or chlorate salt with the reducing agent.

This aspect, taken alone or combinable with any other aspect, can include the following features. The reducing agent is encapsulating in a second polymer before flowing the reducing agent into the subterranean formation at which kerogen is present.

This aspect, taken alone or combinable with any other aspect, can include the following features. The first polymer is a polymer matrix selected from a group that consists of polyvinyl butyral polymer, vinyl acetal polymer, butyral polymers, styrene/-maleic anhydride copolymer, and alkylated vinylpyrrolidone copolymer.

This aspect, taken alone or combinable with any other aspect, can include the following features. The first polymer is an enteric coating, wherein the enteric coating is selected from a group that consists of methylacrylate-methacrylic acid copolymer, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

This aspect, taken alone or combinable with any other aspect, can include the following features. The second polymer is a polymer matrix selected from a group that consists of polyvinyl butyral polymer, vinyl acetal polymer, butyral polymers, styrene/-maleic anhydride copolymer, and alkylated vinylpyrrolidone copolymer.

This aspect, taken alone or combinable with any other aspect, can include the following features. The second polymer is an enteric coating, wherein the enteric coating is selected from a group that consists of methylacrylate-methacrylic acid copolymer, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

This aspect, taken alone or combinable with any other aspect, can include the following features. The reducing agent has a standard reduction potential between that of the bromate or chlorate salt and the corresponding halogen.

This aspect, taken alone or combinable with any other aspect, can include the following features. The reducing agent is selected from a group that consists of sulfur, red phosphorus, bisulfite, iodide, and iodine.

In some implementations, a composition for treating kerogen in a subterranean formation includes a fracturing fluid, and at least one N-halosuccinimide selected from a group consisting of N-bromosuccinimide, N-chlorosuccinimde, and N-iodosuccinimide, wherein the N-halosuccinimide is dissolved in the fracturing fluid, and wherein the N-halosuccinimide is present in the fracturing fluid at a concentration of 0.001M to 0.10M.

This aspect, taken alone or combinable with any other aspect, can include the following features. The fracturing fluid is an aqueous-based fracturing fluid.

This aspect, taken alone or combinable with any other aspect, can include the following features. The fracturing fluid is a carbon-dioxide based fluid.

In some implementations, a composition for treating kerogen in a subterranean formation includes a polymer, at least one N-halosuccinimide selected from a group consisting of N-bromosuccinimide, N-chlorosuccinimide, and N-iodosuccinimide, wherein the N-halosuccinimide is encapsulated in the polymer, and carbon dioxide-based fluid.

This aspect, taken alone or combinable with any other aspect, can include the following features. The polymer is a polymer matrix selected from a group consisting of polyvinyl butyral polymer, vinyl acetal polymer, butyral polymer, styrene/-maleic anhydride copolymer, and alkylated vinylpyrrolidone copolymer.

This aspect, taken alone or combinable with any other aspect, can include the following features. The polymer is an enteric coating selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

This aspect, taken alone or combinable with any other aspect, can include the following features. The encapsulated N-halosuccinimide is dissolved in the carbon dioxide-based fluid at a concentration of 5 to 100 pounds of encapsulated N-halosuccinimide per 1000 gallons of carbon dioxide-based fluid.

In some implementations, a method for treating kerogen in a subterranean formation includes dissolving at least one N-halosuccinimide selected from a group consisting of N-bromosuccinimide, N-chlorosuccinimide, and N-iodosuccinimide in a fracturing fluid to create an N-halosuccinimide solution, and flowing the N-halosuccinimide solution into a subterranean formation at which kerogen is present.

This aspect, taken alone or combinable with any other aspect, can include the following features. The N-halosuccinimide is dissolved in the fracturing fluid at a concentration of 0.001M to 0.10M.

This aspect, taken alone or combinable with any other aspect, can include the following features. The fracturing fluid is an aqueous-based fracturing fluid.

This aspect, taken alone or combinable with any other aspect, can include the following features. The fracturing fluid is a carbon dioxide-based fracturing fluid.

This aspect, taken alone or combinable with any other aspect, can include the following features. The N-halosuccinimide is encapsulated before dissolving the N-halosuccinimide in the fracturing fluid, wherein the encapsulated N-halosuccinimide is dissolved in the fracturing fluid at a concentration of 1 to 100 pounds of encapsulated N-halosuccinimide per 10000 gallons of fracturing fluid.

This aspect, taken alone or combinable with any other aspect, can include the following features. The N-halosuccinimide is encapsulated in a polymer matrix selected from a group consisting of polyvinyl butyral, vinyl acetal polymer, butyral, styrene/-maleic anhydride copolymer, and alkylated vinylprrolidone copolymer.

This aspect, taken alone or combinable with any other aspect, can include the following features. The N-halosuccinimide is encapsulated in an enteric coating selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1A shows the structure of a [P(CF₃)₄]⁺ ion.

FIG. 1B shows the structure of a [N(CF₃)₄]⁺ ion.

FIB. 1C shows the structure of a bis(tri(4-fluorophenyl)phosphine)iminium ion.

FIG. 2 is a flow chart illustrating an example method of treating kerogen in a subterranean formation.

FIG. 3 is a flow chart illustrating an example method of treating kerogen in a subterranean formation.

FIG. 4 is a flow chart illustrating an example method of treating kerogen in a subterranean formation.

FIG. 5A shows an example reaction scheme of homolytic fission of N-bromosuccinimide.

FIG. 5B shows an example reaction scheme of heterolytic fission of N-bromosuccinimide.

FIG. 6 is a flow chart illustrating an example method of treating kerogen in a subterranean formation.

FIG. 7A shows an example scanning electron microscope (SEM) image of a first shale sample before treatment with bromine.

FIG. 7B shows an example SEM image of the first shale sample after treatment with bromine.

FIG. 7C shows an example SEM image of a second shale sample before treatment with bromine.

FIG. 7D shows an example SEM image of the second shale sample after treatment with bromine.

FIG. 7E shows an example SEM image of a third shale sample before treatment with bromine.

FIG. 7F shows an example SEM image of the third shale sample after treatment with bromine.

FIG. 8A shows an example SEM image of a shale sample after treatment with bromine.

FIG. 8B shows an example SEM image of a shale sample after treatment with bromine.

FIG. 8C shows an example SEM image of a shale sample after treatment with bromine.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure, in part, are compositions and methods for generating halogens in situ in a subterranean formation. In this disclosure, the general term “halogen” can refer to any one of the diatomic molecules Br₂, Cl₂, I₂, or F₂, unless otherwise specified.

Bromine (Br₂) is effective at partially depolymerizing kerogen in source rock, which allows it to dissolve in hydrocarbons and flow out of the formation. However, bromine also reacts with metal, such as that found in down-hole tubulars. Therefore, bromine introduced to a well bore could negatively impact the integrity of the tubulars and potentially be consumed, which limits its application in an aqueous system. Encapsulation of bromine itself is difficult because bromine is a volatile liquid. Aside from these chemical considerations, bromine and other halogens are dangerous to handle in the field.

Provided in this disclosure are compositions and methods to generate bromine and other halogens in situ in a subterranean formation, thus minimizing damage to tubulars and other parts of the wellbore, and preventing a halogen from prematurely reacting with materials other than kerogen. In addition, generating the bromine or other halogen in situ reduces the safety considerations necessary in the field.

Generating the bromine or other halogens in situ includes, in some implementations, a delayed generation of the bromine or halogen. This can occur, for example, by the decomposition of precursors, a chemical reaction, the encapsulation of precursors or reactants, or a combination of these approaches.

For example, bromine and other halogens can be generated in situ by the decomposition of polyhalogen salts in a subterranean formation. Polyhalogens include polyatomic anions that contain only halogen atoms. Polyhalogens can contain one or more than one type of halogen atom, for example I₃⁻ or ICl₂⁻.

In some implementations, salts containing polyhalogen ions are encapsulated in a polymer matrix. Polyhalogen salts can be formed by the reaction of halide ions with halogens and heteroatomic congeners to form stable polyhalogen ions. Examples of halogens include F₂, Cl₂, Br₂, and I₂. Examples of halide ions include Cl⁻, Br⁻, and I⁻. Equations 1-6 show examples of the equilibria between halides and halogens and the corresponding polyhalogen ion. The bonding in these polyhalogen ions is relatively weak π-bonding. At temperatures of 130-180° C., these polyhalogen compounds will decompose to yield a halogen and a halide. This decomposition process is accelerated in the presence of water. Therefore, in a subterranean formation where temperatures are sufficiently high or water is present, the polyhalogen ions will decompose to yield halide ions and halogens.

Br⁻+Cl₂↔[Cl₂Br]⁻ (Eq.1)

Br⁻+Br₂↔[Br₃]⁻ (Eq. 2)

Br⁻+I₂↔[BrI₂]⁻ (Eq.3)

Br⁻+3I₂↔[BrI₆]⁻ (Eq.4)

I⁻+I₂↔[I₃]⁻ (Eq. 5)

I⁻+2I₂↔[I₅]⁻ (Eq. 6)

In some implementations, the polyhalogen salt will contain an anion selected from Br₃⁻, Br₂Cl⁻, BrCl₂⁻, BrI₂⁻, Br₂I⁻, I₃⁻, Cl₄⁻, BrI₁⁻, ICl₂⁻, ICl₄⁻, I₃Br₄⁻ and mixtures thereof. The cation in these salts can be an alkali cation or an alkali earth cation, for example Li⁺, Na⁺, K⁺, Mg²⁺, or Ca²⁺. In some implementations, the cation can include a quaternary ammonium cation selected from the group containing tetramethylammonium, tetraethylammonium, tetrabutylammonium, benzyltrimethylammonium, and cetyltrimethylammonium. In some embodiments, the cation can include a quaternary phosphonium cation selected from tetraphenylphosphonium, tetraethylphosphonium, and tetramethylphosphonium. In some implementations, the cation can include an imidazole, for example imidazolium ([Im]⁺), pyridinium ([Pyr]⁺), pyrrolidinium ([Pyrr]⁺), or 1-butyl-3-methyl-imidazolium ([BMIm]⁺).

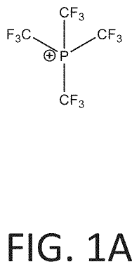

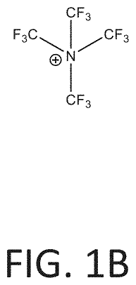

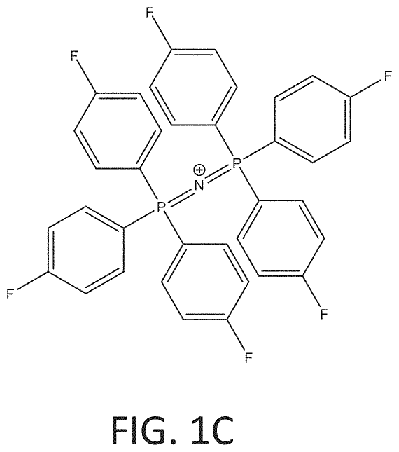

In some implementations, the cation can include fluorine-carbon bonds. Carbon-fluorine bonds reduce the reactivity of a cation and increase the solubility of a salt in organic solvents, for example in carbon dioxide. Cations including carbon-fluorine bonds can include [P(CF₃)₄]⁺ (FIG. 1A), [N(CF₃)₄]⁺ (FIG. 1B), or bis(tri(4-fluorophenyl)phosphine)iminium (FIG. 1C).

In some implementations, a polyhalogen salt can be dissolved into a fluid medium or fracturing fluid that includes carbon dioxide. This fluid can then be used in subterranean formations for hydraulic fracturing operations, and to treat kerogen in the subterranean formation. Once in the subterranean formation, the polyhalogen salt decomposes to yield a halogen, for example bromine, chlorine, or iodine. The halogens react with and degrade or partially degrade kerogen present in the subterranean formation. The degradation of kerogen can improve the hydraulic conductivity of a hydraulic fracture and increase hydrocarbon recovery from the well.

In some implementations, the polyhalogen salt can be encapsulated by incorporation into a polymer. Encapsulation into a polymer can include incorporation or infusion into a polymer matrix. Encapsulation into a polymer can also include being surrounded by an enteric coating.

The polymer may include a polymer matrix, for example polyvinyl butyral polymer, vinyl acetal polymers, butyral polymers, styrene/-maleic anhydride copolymers, or alkylated vinylpyrrolidone copolymers.

In some implementations, the polyhalogen salt can be encapsulated within an enteric coating, for example with methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, or zein.

In some implementations, the encapsulated polyhalogen salt can be mixed into an aqueous or carbon dioxide based fluid or foam. The fluid or foam can then be flowed into the subterranean formation for use in hydraulic fracturing operations.

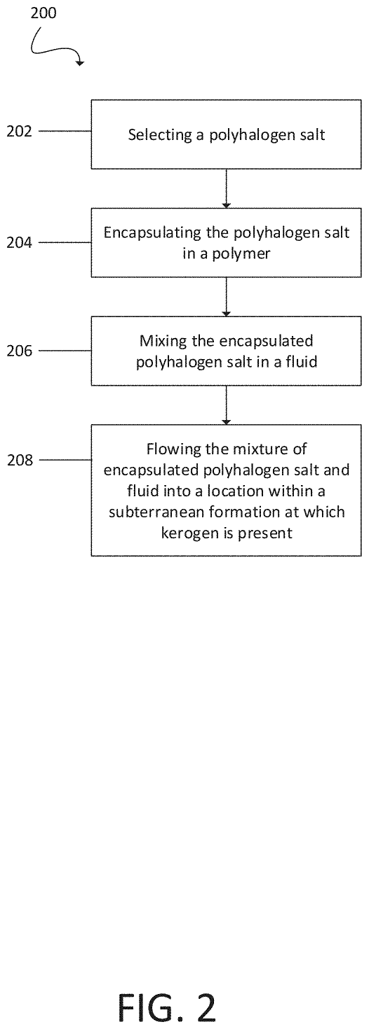

FIG. 2 is an example of a method 200 for treating kerogen in a subterranean zone. At 202, a polyhalogen salt is selected. At 204, the polyhalogen salt is encapsulated in a polymer. At 206, the encapsulated polyhalogen salt is mixed in a fluid. At 208, the mixture of encapsulated polyhalogen salt and fluid is flowed into a location within a subterranean formation at which kerogen is present. In some implementations, the fluid is an aqueous-based fluid. In some implementations, the fluid is a carbon dioxide-based fluid or foam.

Another approach to generate halogens in situ includes the use of an unstable oxo-acid. Unstable oxo-acids include bromic acid (HBrO₃) and chloric acid (HClO₃). HBrO₃ is a strong acid with a pKa of approximately −2, and decomposes to yield bromine. HClO₃ is a strong acid with a pKa of approximately −1, and decomposes to yield chlorine and chlorine dioxide.

Both HBrO₃ and HClO₃ can be formed by protonation of bromate or chlorate, respectively, as shown in Eq. 7, where X is Br or Cl.

$${[ {X O}_{3} ]}^{-} {\to }^{{H}^{+}} {H X O}_{3} \qquad ( Eq . 7 )$$

Accordingly, the unstable oxo-acids can be produced in situ by protonating bromate or chlorate anions with a hydrogen ion. The source of the hydrogen ion H⁺ can be an acid. The acid can be an encapsulated solid, or a free acid in the medium. The bromate and chlorate ions can be present as bromate and chlorate salts with alkali cations, for example Na⁺ and K⁺.

In some implementations, a composition for treating kerogen in a subterranean formation includes at least one bromate or chlorate salt. For example, the composition can include bromate salts, chlorate salts, or a mixture of bromate and chlorate salts. These salts or mixtures of salts can be encapsulated in a first polymer. The first polymer can be a polymer matrix, for example polyvinyl butyral polymer, vinyl acetal polymers, butyral polymers, styrene/-maleic anhydride copolymers, or alkylated vinylpyrrolidone copolymers.

The first polymer can be an enteric coating, for example methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, or zein. The encapsulated bromate or chlorate salt, or mixture of encapsulated bromate and chlorate salt, can be dispersed or suspended in a fluid medium or fracturing fluid. The fracturing fluid can be an aqueous solvent. Alternatively, the fracturing fluid can be a carbon dioxide based fluid or foam.

The composition can also include a hydrogen ion source, for example, an acid. Suitable acids include lactic acid, polylactic acid, chloracetic acid, citric acid, oxalic acid, benzoic acid, furoic acid, or other solid organic acids. Alternatively, the acid can be an inorganic acid, for example hydrochloric acid.

The acid can be encapsulated in a second polymer. The second polymer can be a polymer matrix, for example polyvinyl butyral polymer, vinyl acetal polymers, butyral polymers, styrene/-maleic anhydride copolymers, or alkylated vinylpyrrolidone copolymers. The second polymer can be an enteric coating, for example methylacrylate-methacrylic acid copolymers, cellulose acetate phthalate, cellulose acetate succinate, hydroxypropylmethyl cellulose phthalate, hypromellose acetate succinate polyvinyl acetate phthalate, shellac, cellulose acetate trimellitate, sodium alginate, or zein.

The acid or encapsulated acid can be dissolved in a fluid medium or fracturing fluid to be used in treating kerogen. The fracturing fluid can be an aqueous solution. Alternatively, the fracturing fluid can be a carbon dioxide based fluid or foam.

The encapsulated salt or mixture of encapsulated salts can be flowed into a subterranean formation where kerogen is present. After the salt or mixture of salts has been flowed into the formation, an acid can be flowed into the formation. The polymer matrix or enteric coating degrades in the subterranean formation, and the salts and the acid then come into contact. The protonation of the bromate or chlorate anion results in the formation of an unstable oxo-acids. These oxo-acids then decompose to form their respective halogens, for example bromine from HBrO₃ and chlorine from HClO₃.

In some implementations, the acid can be flowed into a subterranean formation with the same treatment volume as the salt or mixture of salts. In some implementations, the acid can be flowed into a subterranean formation with a different treatment volume than the salt or mixture of salts. In some implementations, the salt or mixture of salts and the acid are flowed into the subterranean formation simultaneously.

In the above described compositions and methods, the encapsulation of one or more polyhalogen salts results in the delayed generation of halogen. The halogen is generated in the subterranean formation that contains kerogen, which results in increased safety and prevents the halogen from reacting prematurely, for example by degrading hydraulic fracturing equipment.

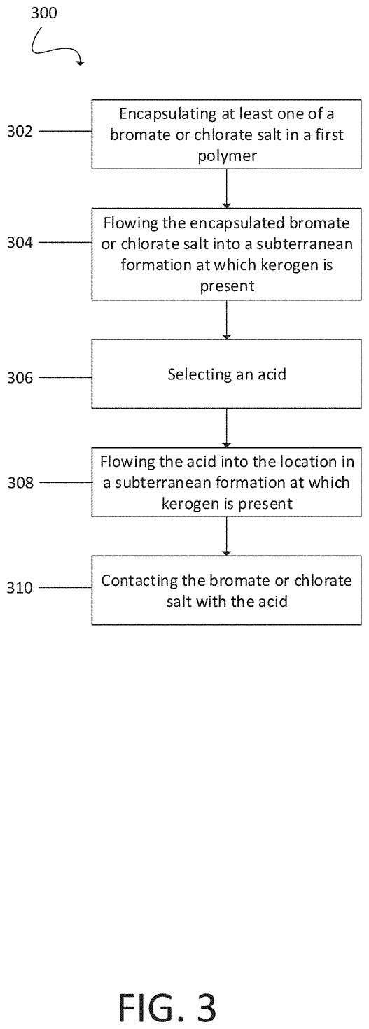

FIG. 3 is an example of a method 300 for treating kerogen in a subterranean zone. At 302, at least one of a bromate or chlorate salt is encapsulated in a first polymer. At 304, the encapsulated bromate or chlorate salt is flowed into a subterranean formation at which kerogen is present. At 306, an acid is selected. At 308, the acid is flowed into the subterranean formation at which kerogen is present. At 310, the bromate or chlorate salt is contacted with the acid.

Another approach for generating halogens in situ is the reduction of chlorate, bromate, or iodate salts. When reduced, salts that contain chlorate, bromate, or iodate anions generate bromine, chlorine, and iodine, respectively (Eq. 8-10).

ClO₃⁻+Redᵢ→Cl₂+Red_{f} (Eq.8)

BrO₃⁻+Redᵢ→Br₂+Red_{f} (Eq.9)

IO₃⁻+Redᵢ→I₂+Red_{f} (Eq.10)

Equations 11 and 12 schematically illustrate how a bromate, chlorate, or iodate anion (XO₃⁻) can react with an initial reducing agent (Redᵢ) to produce a halogen (X₂) and a subsequent reducing agent (Red_{f}), where k₁ represents the rate constant for the reaction. In some circumstances, Redᵢ can react with the generated halogen (X₂) to generate a halide ion (X⁻), where k₂ is the rate constant for the reaction.

$$\begin{matrix}{X O}_{3}^{-} + {Red}_{i} {\to }^{k 1} {X}_{2} + {Red}_{f} & ( Eq . 11 ) \\ {X}_{2} + {Red}_{i} {\to }^{{k}_{2}} {X}^{-} + {Red}_{f} & ( Eq . 12 )\end{matrix}$$

In situations where k₂ is much less than k₁, equation 11 will occur at a faster rate than equation 12, meaning X₂ is not substantially consumed by Redᵢ. In this situation, the majority of X₂ is available for reaction with kerogen. Inversely, if k₂ is greater than k₁, the halogen X₂ may be consumed by Redᵢ before it reacts with kerogen. Therefore reducing agents with a faster rate of reaction with oxo-anions (XO₃⁻) relative to halogens (X₂) are suitable for generating halogens to treat kerogen.

Another approach for the efficient reduction of oxo-anions is to use a reducing agent with a standard oxidation potential (Q) between that of the halogen and the oxo-anion. This ensures that the reduction of oxo-anions is more favorable than the reduction of halogens.

For example, the reaction between bromate and a reducing agent Redᵢ can be expressed as two half reactions:

2[BrO₃]⁻+12H⁺+10e⁻→Br₂+6H₂O E_{red}=1.48V (Eq.13)

Redᵢ−Red_{f}+2e⁻ Eₒₓ=Q (Eq.14)

where E_{red} and Eₒₓ are the standard reduction and oxidation potentials of the respective half reactions.

Similarly, the reaction between bromine and a reducing agent Redᵢ can be expressed as two half reactions:

Br₂+2e⁻→2Br⁻ E_{red}=1.08V (Eq.15)

Redᵢ→Red_{f}+2e⁻ Eₒₓ=Q (Eq.16)

where E_{red} and Eₒₓ are the standard reduction and oxidation potentials of the respective half reactions.

The difference in the reduction and oxidation potentials (E_{red}−Eₒₓ) indicates whether the overall oxidation-reduction reaction is thermodynamically favorable. If the difference in reduction and oxidation potentials is positive, the reaction is favorable.

Accordingly, if Q is between 1.48V and 1.08V, the reduction of bromate will be thermodynamically favorable whereas the reduction of Br₂ will not be thermodynamically favorable.

As an illustration, if the reducing agent Redᵢ has an oxidation potential Q of 1.2V, the difference in reduction and oxidation potentials between the bromate anion and the reducing agent will be 1.48V−1.2V, or 0.28V The positive difference indicates that the reaction is thermodynamically favorable. However, the difference in reduction and oxidation potentials between the halogen Br₂ and the reducing agent will be 1.08V−1.2V, or −0.12V. The negative difference indicates that the reaction is thermodynamically unfavorable.

As these examples illustrate, a reducing agent with a standard oxidation potential between that of the oxo-anion and the halogen will react favorably with the oxo-anion. This ensures that the halogen generated by the reduction of the oxo-anion will be largely available for the treatment of kerogen, as opposed to being consumed by the reducing agent.

As discussed so far in this application, reducing agents with kinetic factors that make them more reactive to the oxo-anions than to the halogen, or reducing agents with a standard reduction potential between the oxo-anion and the halogen are suitable reducing agents. However, these are not necessary characteristics of the reducing agent, and other reducing agents without these kinetic or thermodynamic properties may also be suitable for reducing oxo-anions.

A composition including oxo-anions and reducing agents can be used to treat kerogen. In some implementations, the oxo-anions are encapsulated and the reducing agent is unencapsulated. In some implementations, the reducing agent is encapsulated and the oxo-anions are unencapsulated. In some implementations, the oxo-anions and the reducing agent are both encapsulated.

In some implementations, a composition to treat kerogen in a subterranean formation includes a bromate salt, a chlorate salt, an iodate salt, or mixtures thereof, where the salt or mixture of salts are encapsulated in a first polymer. The composition also includes a reducing agent.

In some implementations, the first polymer is a polymer matrix, for example a polyvinyl butyral polymer, vinyl acetal polymer, butyral polymer, styrene/-maleic anhydride copolymer, or alkylated vinylpyrrolidone copolymer.

In some implementations, the first polymer can be an enteric coating, for example, methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, or zein.

In some implementations, the reducing agent can have a standard reduction potential between that of the bromate or chlorate salt and the corresponding halogen. For bromate salts, the corresponding halogen is bromine. For chlorate salts, the corresponding halogen is chlorine. For iodate salts, the corresponding halogen is iodine.

In some implementations, the reducing agent can be sulfur, red phosphorus, bisulfite, iodide, or iodine.

In some implementations, the reducing agent is encapsulated in a second polymer. The second polymer can be a polymer matrix, for example a polyvinyl butyral polymer, vinyl acetal polymer, butyral polymer, styrene/-maleic anhydride copolymer, or alkylated vinylpyrrolidone copolymer. In some implementations, the second polymer can be an enteric coating, for example methyacrylate-methacrylic acid copolymer, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, or zein.

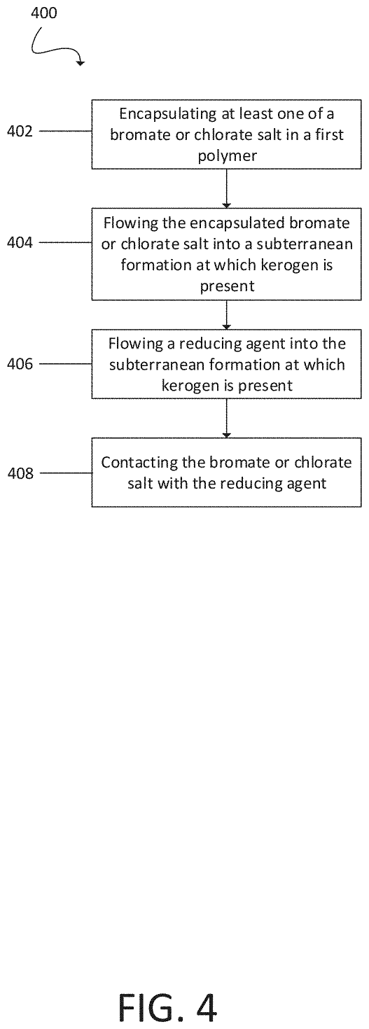

FIG. 4 shows an example of a method for treating kerogen in a subterranean zone 400 includes encapsulating the at least one of a bromate, chlorate, or iodate salt in a first polymer. At 402, the encapsulated salt or salts are flowed into a subterranean formation where kerogen is present. At 406, a reducing agent is flowed into the subterranean formation where kerogen is present. At 408, the salt or salts are then in contact with the reducing agent.

In the above described compositions and methods, the halogen is not generated until the salt or salts are in contact with the reducing agent. This happens in the subterranean formation, and therefore the reactive halogen is not generated prematurely, such as above ground or in transit to the subterranean formation. This results in increased safety and prevents the halogen from degrading drilling equipment.

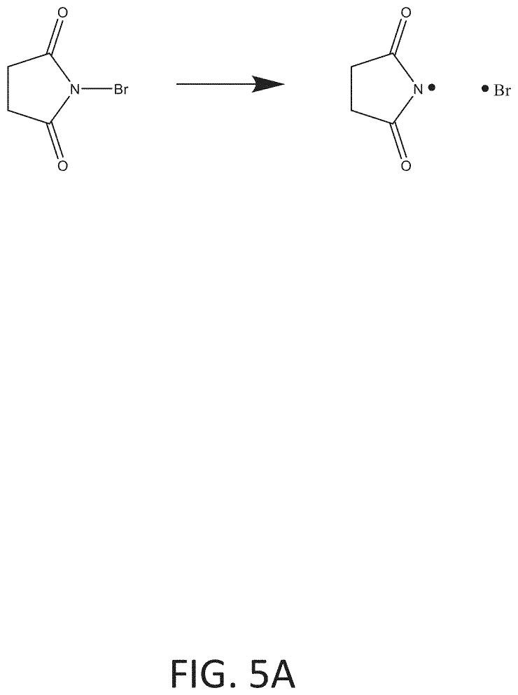

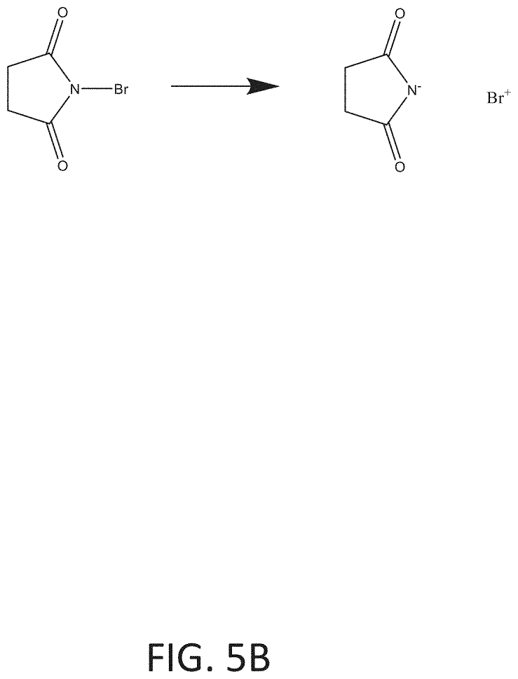

Another approach for generating a halogen in situ is the use of N-halosuccinimides, for example N-bromosuccinimide, N-chlorosuccinimide, or N-iodosuccinimide. These compounds are soluble in organic solvents as well as in water. Homolytic or heterolytic fissions of these compounds results in a halogen radical or halogen ion. For example, the homolytic fission of N-bromosuccinimide results in a bromine radical (FIG. 5A). The heterolytic fission of N-bromosuccinimide results in bromonium (FIG. 5B). Fission can occur upon exposure of the N-halosuccinimides to heat or light. In some implementations, heat from the subterranean formation can initiate the reaction. Radical initiators such as benzoyl peroxide can also be used. The halogen radical or halonium can react with and degrade kerogen.

N-halosuccinimides are solids at room temperature, stable, and easy to handle. N-halosuccinimides can be dissolved in an aqueous or organic solvents prior to being injected into a well. The stability prior to solubilization and the solubility in both aqueous and organic solvents make these compounds safe and practical means for generating halogens to treat kerogen.

In some implementations, a composition for treating kerogen in a subterranean formation includes at least one N-halosuccinimide dissolved in a fracturing fluid. The concentration of the N-halosuccinimde in the fracturing fluid can be between 0.001M and 0.10M. In some implementations, the fracturing fluid is an aqueous-based fluid. In some implementations, the fracturing fluid is a carbon dioxide-based fluid or foam.

In some implementations, an N-halosuccinimide can be encapsulated. Encapsulation of the N-halosuccinimide delays its reaction with substrate. Once the radical or halonium forms, it can react quickly with available reducing agents. Encapsulation can delay the reaction of the radical or halonium until it has reached kerogen in the formation. In addition, other available reducing agents that are inherent in the formation could potentially react with the radical or halonium before they reach the kerogen. In some implementations, the N-halosuccinimide is encapsulated in a polymer and dissolved in a carbon dioxide-based fluid or foam. The polymer can be a polymer matrix, for example a polyvinyl butyral polymer, vinyl acetal polymer, butyral polymer, styrene/-maleic anhydride copolymer, or alkylated vinylpyrrolidone copolymer. In some implementations, the polymer can be an enteric coating, for example methylacrylate methacrylic acid copolymer, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, or zein.

The encapsulated N-halosuccinimide can be dissolved in a carbon-dioxide based fluid at a concentration of 5 to 100 pounds of encapsulated N-halosuccinimide per 1000 gallons of carbon dioxide-based fluid.

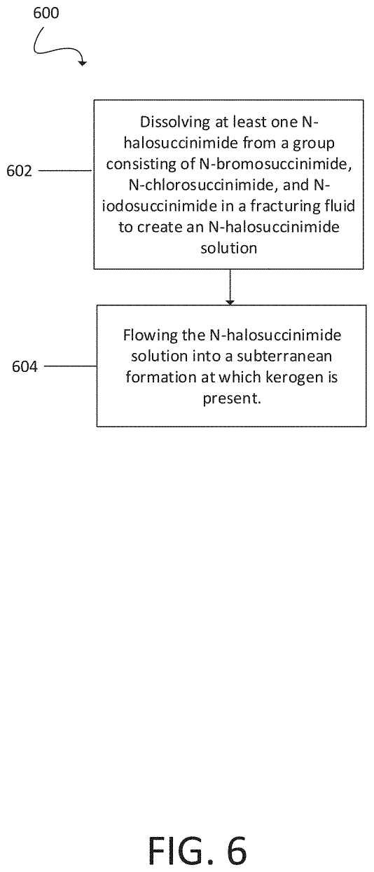

FIG. 6 shows an example of a method 600 for treating kerogen in a subterranean formation. At 602, at least one N-halosuccinimide from a group consisting of N-bromosuccinimide, N-chlorosuccinimide, and N-iodosuccinimide is dissolved in a fracturing fluid to create an N-halosuccinimide solution. At 604, the N-halosuccinimide solution is flowed into a subterranean formation at which kerogen is present.

As N-halosuccinimides are stable chemicals, the generation of the halogen radicals or ions is delayed until they reach the subterranean zone and are therefore safer to use in the field than native halogens.

### EXAMPLES

### Example 1: Reaction of Bromine with Kerogen in a Water-Based Medium

Kerogen samples can be segregated into samples with relatively low pyrite concentration and relatively high concentration using density liquid separation, for example with zinc bromide. Kerogen samples with relatively low pyrite concentration float (<1.8 g/cc) whereas sample with relatively higher pyrite concentration sink (>1.8 g/cc). A piece of floated, thermally mature kerogen weighing 101.9 mg was suspended in 25 mL of de-ionized water in a glass pressure tube. Next, 0.17 mL (3.3 mmol) of Br₂ was added to the mixture, and the tube was sealed and heated to 150° C. in an oil bath for 3 hours. The mixture was then filtered and the isolated kerogen collected, dried, and weighed. The mass of the kerogen before treatment was 99.1 mg. The mass of the kerogen after treatment was 122.9 mg. Therefore, there was a greater that 20% increase in mass that can be attributed to the reaction of bromine with the kerogen sample.

### Example 2: Reaction of Bromine in Supercritical CO₂ with Shale Rock Samples #1-3

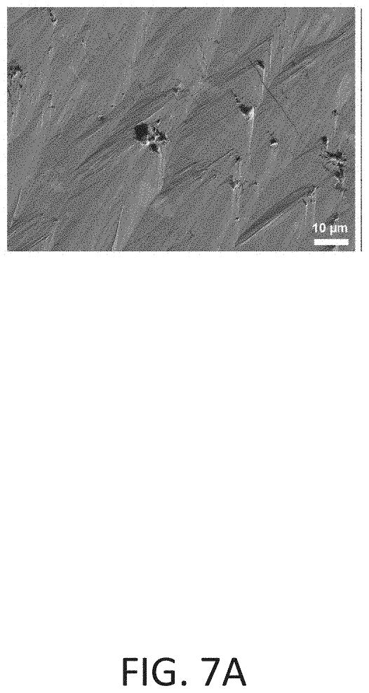

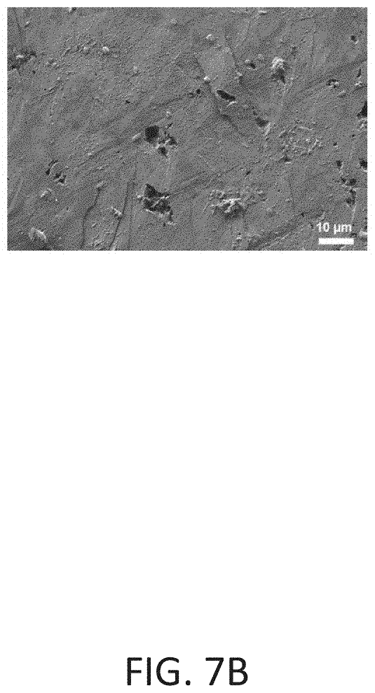

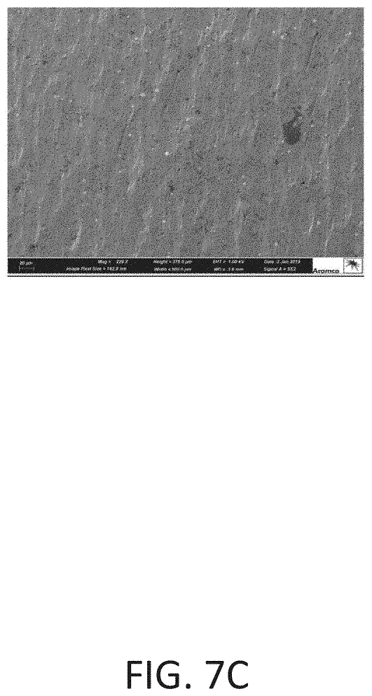

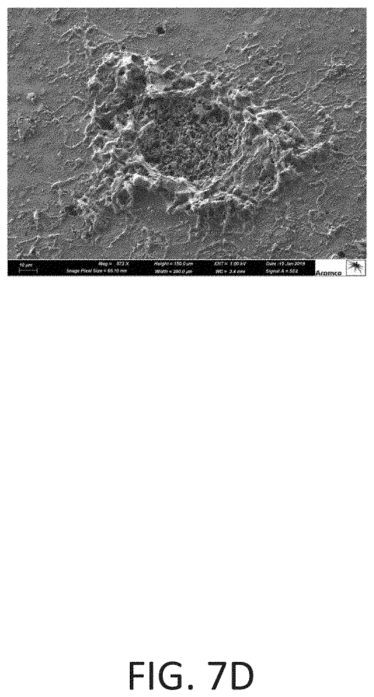

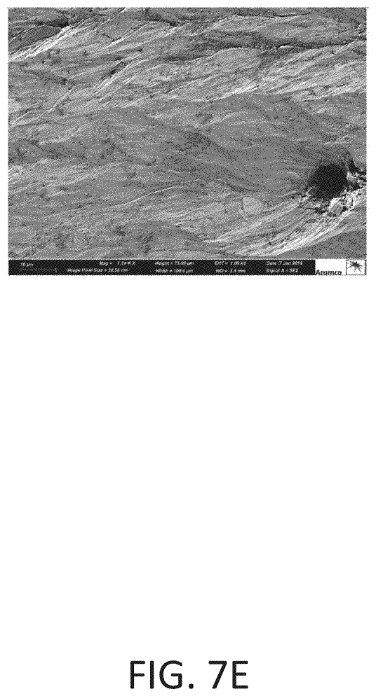

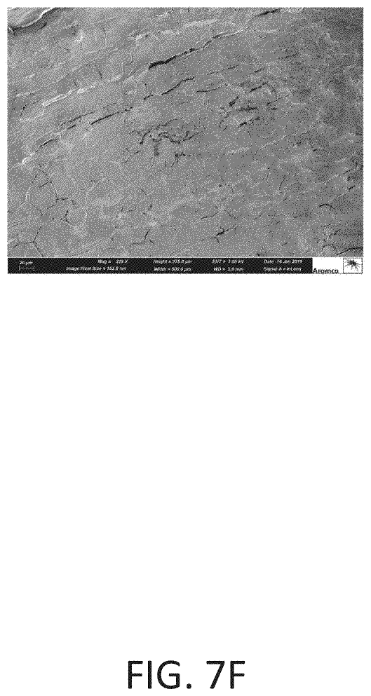

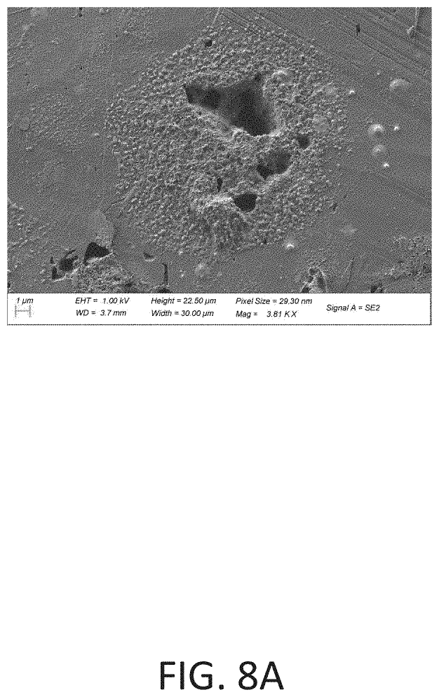

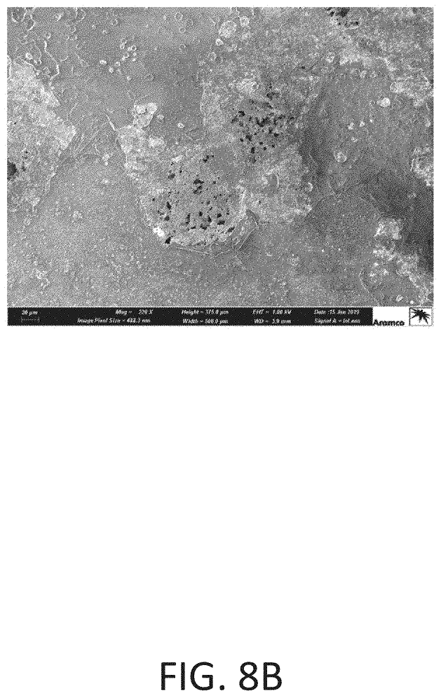

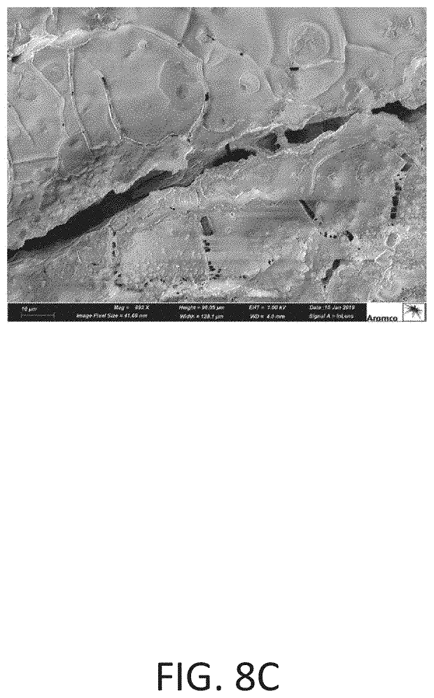

Shale rock samples #1-3, each with the mineralogical composition given in Table 1, were cut into 1 cm×1 cm×1.5 cm rectangular prisms and broad ion-beam polished to afford a flack surface. The samples were then individually placed in a 750 mL high-pressure autoclave composed of corrosion resistant metal alloy. Next, 3 mL of bromine (60 mmol) was added to the samples and the remainder of the autoclave was filled with liquid CO₂ at 800 psi. The autoclave was then sealed and heated to 150° C. for 20 hours at a pressure of 2600 psi before being allowed to cool. Scanning electron microscopy (SEM) images of each shale sample before and after treatment were obtained. The first shale sample is shown before treatment in FIG. 7A. The first shale sample is shown after treatment in FIG. 7B. The second shale sample is shown before treatment in FIG. 7C. The second shale sample is shown after treatment in FIG. 7D. The third shale sample is shown before treatment in FIG. 7E. The third shale sample is shown after treatment in FIG. 7F. After treatment with bromine, “eruptions” of brominated kerogen are observed in the shale rock samples, representing partially depolymerized kerogen (FIGS. 8A-C).

TABLE 1
Mineralogy of polish shale sample before treatment

| | Sample 1 | Sample 2 | Sample 3 |
|---|---|---|---|
| Quartz | 30 | 72 | 25 |
| Albite | 9 | 5 | 4 |
| Orthoclase | 2 | 1 | 8 |
| Chlorite | 9 | 1 | 2 |
| Illite/Mica | 35 | 15 | 34 |
| Illite/Smectite | 7 | 4 | 14 |
| Pyrite | Trace | 1 | 10 |
| Anatase | 2 | Trace | 0.4 |
| Siderite | 5 | 0 | 0 |
| Kaolinite | 1 | Trace | 5 |
| Gypsum | 0 | Trace | 0 |
| Dolomite | 0 | 1 | 0 |

The term “about” as used in this disclosure can allow for a degree of variability in a value or range, for example, within 10%, within 5%, or within 1% of a stated value or of a stated limit of a range.

The term “substantially” as used in this disclosure refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “solvent” as used in this disclosure refers to a liquid that can dissolve a solid, another liquid, or a gas to form a solution. Non-limiting examples of solvents are silicones, organic compounds, water, alcohols, ionic liquids, and supercritical fluids.

The term “room temperature” as used in this disclosure refers to a temperature of about 15 degrees Celsius (° C.) to about 28° C.

The term “downhole” as used in this disclosure refers to under the surface of the earth, such as a location within or fluidly connected to a wellbore.

As used in this disclosure, the term “fracturing fluid” refers to fluids or slurries used downhole during fracturing operations.

As used in this disclosure, the term “fluid” refers to liquids and gels, unless otherwise indicated.

As used in this disclosure, the term “subterranean material” or “subterranean zone” refers to any material under the surface of the earth, including under the surface of the bottom of the ocean. For example, a subterranean zone or material can be any section of a wellbore and any section of a subterranean petroleum- or water-producing formation or region in fluid contact with the wellbore. Placing a material in a subterranean zone can include contacting the material with any section of a wellbore or with any subterranean region in fluid contact the material. Subterranean materials can include any materials placed into the wellbore such as cement, drill shafts, liners, tubing, casing, or screens; placing a material in a subterranean zone can include contacting with such subterranean materials. In some examples, a subterranean zone or material can be any downhole region that can produce liquid or gaseous petroleum materials, water, or any downhole section in fluid contact with liquid or gaseous petroleum materials, or water. For example, a subterranean zone or material can be at least one of an area desired to be fractured, a fracture or an area surrounding a fracture, and a flow pathway or an area surrounding a flow pathway, in which a fracture or a flow pathway can be optionally fluidly connected to a subterranean petroleum- or water-producing region, directly or through one or more fractures or flow pathways.

As used in this disclosure, “treatment of a subterranean zone” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, aquifer remediation, identifying oil rich regions via imaging techniques, and the like.

As used in this disclosure, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some implementations, a flow pathway can be a water source and can include water. In some implementations, a flow pathway can be a petroleum source and can include petroleum. In some implementations, a flow pathway can be sufficient to divert water, a downhole fluid, or a produced hydrocarbon from a wellbore, fracture, or flow pathway connected to the pathway.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

A number of implementations of the disclosure have been described. Nevertheless, it will be understood that various modifications may be made without departing from the spirit and scope of the disclosure.

What is claimed is:

1. A composition for treating kerogen in a subterranean formation, comprising:
a fracturing fluid; and
at least one N-halosuccinimide selected from a group consisting of N-bromosuccinimide, N-chlorosuccinimde, and N-iodosuccinimide,
wherein the N-halosuccinimide is dissolved in the fracturing fluid, and wherein the N-halosuccinimide is present in the fracturing fluid at a concentration of 0.001M to 0.10M.

2. The composition of claim 1, wherein the fracturing fluid is an aqueous-based fracturing fluid.

3. The composition of claim 1, wherein the fracturing fluid is a carbon-dioxide based fluid.

4. A composition for treating kerogen in a subterranean formation, comprising:
a polymer;
at least one N-halosuccinimide selected from a group consisting of N-bromosuccinimide, N-chlorosuccinimide, and N-iodosuccinimide, wherein the N-halosuccinimide is encapsulated in the polymer; and
carbon dioxide-based fluid.

5. The composition of claim 4, wherein the polymer is a polymer matrix selected from a group consisting of polyvinyl butyral polymer, vinyl acetal polymer, butyral polymer, styrene/-maleic anhydride copolymer, and alkylated vinylpyrrolidone copolymer.

6. The composition of claim 4, wherein the polymer is an enteric coating selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.

7. The composition of claim 4, wherein the encapsulated N-halosuccinimide is dissolved in the carbon dioxide-based fluid at a concentration of 5 to 100 pounds of encapsulated N-halosuccinimide per 1000 gallons of carbon dioxide-based fluid.

8. A method for treating kerogen in a subterranean formation, comprising
dissolving at least one N-halosuccinimide selected from a group consisting of N-bromosuccinimide, N-chlorosuccinimide, and N-iodosuccinimide in a fracturing fluid to create an N-halosuccinimide solution; and
flowing the N-halosuccinimide solution into a subterranean formation at which kerogen is present.

9. The method of claim 8, wherein the dissolving at least one N-halosuccinimide in a fracturing fluid comprises dissolving at least one N-halosuccinimide in the fracturing fluid at a concentration of 0.001M to 0.10M.

10. The method of claim 8, wherein the fracturing fluid is an aqueous-based fracturing fluid.

11. The method of claim 8, wherein the fracturing fluid is a carbon dioxide-based fracturing fluid.

12. The method of claim 11, further comprising encapsulating at least one N-halosuccinimide before dissolving the N-halosuccinimide in the fracturing fluid, wherein the encapsulated N-halosuccinimide is dissolved in the fracturing fluid at a concentration of 1 to 100 pounds of encapsulated N-halosuccinimide per 10000 gallons of fracturing fluid.

13. The method of claim 12, wherein encapsulating the N-halosuccinimide further comprises encapsulating the N-halosuccinimide in a polymer matrix selected from a group consisting of polyvinyl butyral, vinyl acetal polymer, butyral, styrene/-maleic anhydride copolymer, and alkylated vinylprrolidone copolymer.

14. The method of claim 12, wherein encapsulating the N-halosuccinimide further comprises encapsulating the N-halosuccinimide in an enteric coating selected from a group consisting of methylacrylate-methacrylic acid copolymers, cellulose acetate phthalate, cellulose acetate succinate, hydroxypropylmethyl cellulose phthalate, hypromellose acetate succinate, polyvinyl acetate phthalate, shellac, cellulose acetate trimellitate, sodium alginate, and zein.
